(19) United States
(12) Patent Application Publication
(10) Pub. No.: US 2022/0285806 A1
(43) Pub. Date: Sep. 8, 2022

(54) LIQUID INJECTION DEVICE AND LIQUID INJECTION METHOD

(71) Applicant: KABUSHIKI KAISHA TOSHIBA, Tokyo (JP)

(72) Inventor: Tomomichi NAKA, Chigasaki (JP)

(73) Assignee: KABUSHIKI KAISHA TOSHIBA, Tokyo (JP)

(21) Appl. No.: 17/645,593

(22) Filed: Dec. 22, 2021

(30) Foreign Application Priority Data
Mar. 3, 2021 (JP) 2021-033523

(51) Int. Cl. H01M 50/618; H01M 50/636

(52) U.S. Cl. CPC H01M 50/618; H01M 50/636

(57) ABSTRACT

According to an embodiment, a liquid injection device includes a liquid injection chamber, a liquid injector, a pressure regulator and a controller. The liquid injection chamber accommodates a battery, including an exterior container provided with a liquid injection port, in an initial state. The liquid injector injects an electrolytic solution into the exterior container through the liquid injection port, in the liquid injection chamber. The controller controls an action of the pressure regulator to bring the liquid injection chamber to a depressurized state, where the pressure is lower than in the initial state, and then bring the liquid injection chamber to a pressurized state, where the pressure is higher than in the initial state.

### CROSS-REFERENCE TO RELATED APPLICATIONS

This application is based upon and claims the benefit of priority from Japanese Patent Application No. 2021-033523, filed Mar. 3, 2021; the entire contents of which are incorporated herein by reference.

### FIELD

Embodiments relate to a liquid injection device and a liquid injection method.

### BACKGROUND

In a manufacturing process of a battery, by changing the pressure in a liquid injection chamber provided in a liquid injection device, an electrolytic solution is injected into an exterior container of the battery, which is provided with a liquid injection port, by use of, for example, a hopper as a liquid injector. An electrode group disposed in the exterior container is impregnated with the injected electrolyte solution. When injecting an electrolytic solution as described above, the liquid injection device is required to have the electrode group appropriately impregnated with the electrolyte solution in a short time.

### BRIEF DESCRIPTION OF THE DRAWINGS

FIG. 1 is a schematic view showing an example of a liquid injection device according to an embodiment.

FIG. 2 is a schematic view showing a state where a liquid injector is connected to a liquid injection port of a battery in the liquid injection device according to the embodiment.

FIG. 3 is a schematic view showing a state where the liquid injector is connected to the liquid injection port of the battery and a liquid injection chamber is depressurized in the liquid injection device according to the embodiment.

FIG. 4 is a view showing a state where the liquid injector is connected to the liquid injection port of the battery and the liquid injection chamber is pressurized in the liquid injection device according to the embodiment.

FIG. 5 is a graph showing examples of a temporal change of the pressure inside the liquid injection chamber during liquid injection in the liquid injection device according to the embodiment.

FIG. 6 is a flowchart showing an example of processing executed by a controller in a state where a battery has been transferred to the liquid injection chamber in the liquid injection device according to the embodiment.

FIG. 7 is a flowchart showing another example of the processing executed by the controller in the state where a battery has been transferred to the liquid injection chamber in the liquid injection device according to the embodiment.

### DETAILED DESCRIPTION

According to an embodiment, a liquid injection device includes a liquid injection chamber, a liquid injector, a pressure regulator, and a controller. The liquid injection chamber accommodates a battery in an initial state. The battery includes an exterior container provided with a liquid injection port. The liquid injector injects an electrolytic solution into the exterior container through the liquid injection port, in the liquid injection chamber. The pressure regulator adjusts the pressure inside the liquid injection chamber. The controller controls the action of the pressure regulator to bring the liquid injection chamber to depressurized state, in which the pressure is lower than in the initial state, and then bring the liquid injection chamber to a pressurized state, in which the pressure is higher than in the initial state.

Hereinafter, an embodiment will be described with reference to the accompanying drawings.

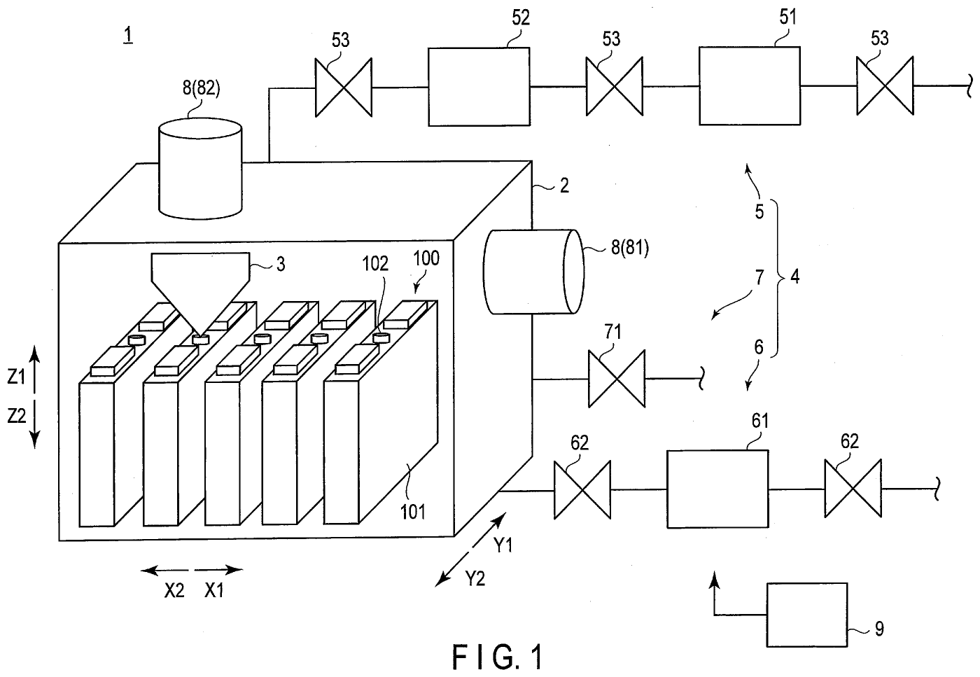

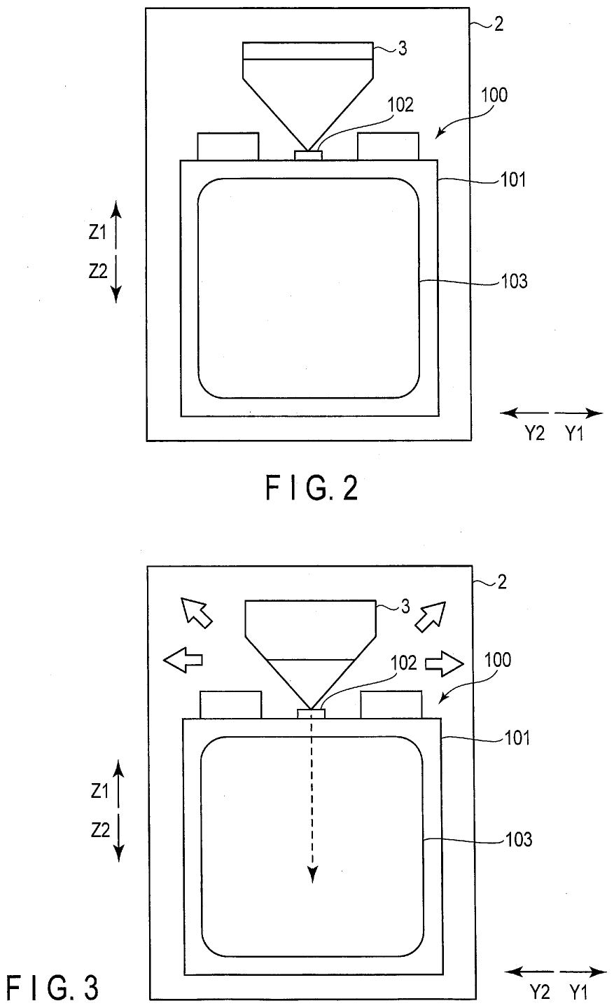

FIG. 1 shows an example of a liquid injection device 1 according to an embodiment. The liquid injection device 1 injects an electrolytic solution into an exterior container 101 of a battery 100. In an example, the liquid injection device 1 injects an electrolytic solution into an inner hollow formed by the exterior container 101 of the battery 100, through a liquid injection port 102 formed in the exterior container 101 of the battery 100. In the inner hollow of the exterior container 101, an electrode group 103 (see FIGS. 2 to 4, etc.) including a positive electrode, a negative electrode and a separator is housed. The battery 100 is, for example, a lithium ion battery. The electrolytic solution is, for example, an organic solvent

The liquid injection device 1 includes a liquid injection chamber 2, a liquid injector 3, a pressure regulator 4, a detection mechanism 8, and a controller 9. The pressure regulator 4 includes a pressurizer 5, a depressurizer 6, and a pressure release 7. The pressurizer is provided in the pressure regulator 4 as a structure separate from the depressurizer 6. In the liquid injection chamber 2, a vertical direction (direction indicated by arrow Z1 and arrow Z2), a first horizontal direction (direction indicated by arrow X1 and arrow X2) which intersects (is orthogonal to or approximately orthogonal to) the vertical direction, and a second horizontal direction (direction indicated by arrow Y1 and arrow Y2) which intersects (is orthogonal to or approximately orthogonal to) the vertical direction and the first horizontal direction are defined.

In the liquid injection chamber 2, an electrolytic solution is injected into the battery 100 provided as a liquid injection target. For example, the battery 100 is brought into the liquid injection chamber 2 through a transfer path (not shown). The battery 100 may be brought into the liquid injection chamber 2 by being placed on a transfer stand, such as a transfer tray. The battery 100 is brought into the liquid injection chamber 2 while the liquid injection chamber 2 is in the initial state to be described later. The pressure inside the liquid injection chamber 2 is adjusted by the pressure regulator 4 to be described later. The liquid injection chamber 2 can be sealed to the outside of the liquid injection chamber 2. The liquid injection chamber 2 preferably has a pressure-resistant shape. The liquid injection chamber 2 has, for example, a cylindrical or approximately cylindrical shape, or a spherical shell or approximately spherical shell shape. The shape of the liquid injection chamber 2 is not limited to these. The liquid injection chamber 2 may be disposed in a container for accommodating the liquid injection chamber 2.

The liquid injector 3 injects an electrolytic solution into the battery 100 provided as a liquid injection target. The liquid injector 3 is, for example, a hopper. The liquid injector 3 can retain therein an electrolytic solution supplied from the outside of the liquid injector 3. The liquid injector 3 injects an electrolytic solution retained therein into the liquid injection target. The liquid injector 3 is disposed in the liquid injection chamber 2. The liquid injector 3 can move within the liquid injection chamber 2. By being driven by a driver (not shown), the liquid injector can be moved as appropriate to a position that enables injection of an electrolytic solution into the liquid injection target disposed in the liquid injection chamber 2. The movement direction of the liquid injector 3 is not particularly limited as long as the liquid injector 3 can move without touching the liquid injection target.

The pressure regulator 4 adjusts the pressure inside the liquid injection chamber 2. The pressure regulator 4 connects the inside of the liquid injection chamber 2 to the outside thereof. In the present embodiment, the pressurizer 5 connects the inside to the outside of the liquid injection chamber 2, the depressurizer 6 connects the inside to the outside of the liquid injection chamber 2, and the pressure release 7 connects the inside to the outside of the liquid injection chamber 2.

The pressurizer 5 increases the pressure inside the liquid injection chamber 2. The configuration of the pressurizer 5 is not particularly limited as long as the pressurizer 5 can increase the pressure inside the liquid injection chamber 2. The configuration of the pressurizer 5 can be changed as appropriate depending on, for example, the liquid injection target. As in the example shown in FIG. 1, the pressurizer 5 of the present embodiment includes a booster 51, a pressurized sub tank 52, and valves 53. The pressurizer 5 is supplied with a gas for pressurizing the liquid injection chamber 2 from outside the pressurizer 5. The gas to be supplied is, for example, dry air. The valves 53 are provided respectively between the liquid injection chamber 2 and the pressurized sub tank 52, between the pressurized sub tank 52 and the booster 51, and between the booster 51 and a supply source of a gas from the outside. The pressurizer 5 forms a pressurization line for increasing the pressure inside the liquid injection chamber 2. By driving the booster 51 and releasing the valves 53 to pressurize the inside of the liquid injection chamber 2, the pressure inside the liquid injection chamber 2 becomes higher than the pressure outside the liquid injection chamber 2 (pressurized state). When the pressure outside the liquid injection chamber 2 matches or approximately matches the atmospheric pressure, the pressure inside the liquid injection chamber 2 becomes higher than the atmospheric pressure.

The depressurizer 6 decreases the pressure inside the liquid injection chamber 2. The configuration of the depressurizer 6 is not particularly limited as long as the depressurizer 6 can decrease the pressure inside the liquid injection chamber 2. The configuration of the depressurizer 6 can be changed as appropriate depending on, for example, the liquid injection target. As in the example shown in FIG. 1, the depressurizer 6 of the present embodiment includes a depressurization pump 61 and valves 62. In the depressurizer 6, the depressurization pump 61 is connected to the liquid injection chamber 2 via a valve 62. The depressurization pump 61 is connected to another valve (exhaust valve) 62. The depressurizer 6 forms a depressurization line for decreasing the pressure inside the liquid injection chamber 2. By driving the depressurization pump 61 and releasing the valves 62 to depressurize the inside of the liquid injection chamber 2, the pressure inside the liquid injection chamber 2 becomes lower than the pressure outside the liquid injection chamber 2 (depressurized state). When the pressure outside the liquid injection chamber 2 matches or approximately matches the atmospheric pressure, the liquid injection chamber 2 is brought to a state where the pressure therein is lower than the atmospheric pressure.

The pressure release 7 makes the pressure inside the liquid injection chamber 2 the same or approximately the same as the pressure outside the liquid injection chamber 2 by releasing the pressure inside the liquid injection chamber 2. The configuration of the pressure release 7 is not particularly limited as long as the pressure release 7 can make the pressure inside the liquid injection chamber 2 the same or approximately the same as the pressure outside the liquid injection chamber 2. The configuration of the pressure release 7 can be changed as appropriate depending on, for example, the liquid injection target. As in the example shown in FIG. 1, the pressure release 7 of the present embodiment includes a leak valve 71. The leak valve 71 is connected to the liquid injection chamber 2. Release of the leak valve 71 allows the inside of the liquid injection chamber 2 to communicate with the outside thereof so that the pressure inside the liquid injection chamber 2 becomes the same or approximately the same as the outside pressure. The pressure outside the liquid injection chamber 2 matches or approximately matches, for example, the atmospheric pressure. In this case, release of the leak valve 71 (exposure to the atmosphere) brings the liquid injection chamber 2 to a state where the pressure therein matches or approximately matches the atmospheric pressure (atmospheric pressure state).

The detection mechanism 8 detects information on liquid injection by the liquid injector 3. The detection mechanism 8 is, for example, a laser sensor or a camera. As in the example shown in FIG. 1, the detection mechanism 8 of the present embodiment includes a first detection mechanism 81 and a second detection mechanism 82. The first detection mechanism 81 detects information on the electrolytic solution retained in the liquid injector 3. The information on the electrolytic solution includes information on the liquid level of the electrolytic solution and information on the liquid volume of the electrolytic solution. The second detection mechanism 82 detects information on the position of the liquid injector 3 within the liquid injection chamber 2. The information on the position of the liquid injector 3 includes information on the position of the liquid injector in the first horizontal direction, information on the position of the liquid injector 3 in the second horizontal direction, and information on the position of the liquid injector 3 in the vertical direction.

The positions of the first detection mechanism 81 and the second detection mechanism 82 are not particularly limited as long as the first detection mechanism 81 and the second detection mechanism 82 can appropriately detect a detection target (detection target information). In the example of FIG. 1, the first detection mechanism 81 is disposed at the same or approximately the same position as the hopper, which serves as the liquid injector 3, according to the vertical direction. The second detection mechanism 82 is disposed above both of the battery 100, which is provided as the liquid injection target, and the hopper, which serves as the liquid injector 3, according to the vertical direction. The first detection mechanism 81 and the second detection mechanism 82 may be provided inside the liquid injection chamber 2 or outside the liquid injection chamber 2.

The controller 9 is, for example, a computer. The controller 9 includes a processor or integrated circuit (control circuit) including, for example, a central processing unit (CPU), an application specific integrated circuit (ASIC), or a field programmable gate array (FPGA), and a storage medium such as a memory. The controller 9 may include one integrated circuit or the like, or a plurality of integrated circuits or the like. The controller 9 performs processing by executing a program or the like stored in the storage medium or the like. The controller 9 controls the liquid injection by the liquid injector 3, the pressurization, depressurization, and pressure release of the liquid injection chamber 2 by the pressure regulator 4 (the pressurizer 5, the depressurizer 6, and the pressure release 7), the action of the detection mechanism 8 (the first detection mechanism 81 and the second detection mechanism 82), and the like.

The liquid injection device 1 may be provided with a user interface. The user interface includes an operation member. On the operation member, a command on an operation of the liquid injection device 1 is input by an operator or the like. Examples of the operation member include a button, a dial, and a touch panel. The user interface may include a notification section which notifies the operator or the like of information. The notification section makes a notification through a screen display, emission of a sound, lighting of a light, or the like. The notification section reports, for example, information that needs to be recognized by the operator and warning information to the operator.

FIGS. 2 to 4 are schematic views showing a liquid injection operation to the battery 100 provided as the liquid injection target. In FIGS. 2 to 4, the first horizontal direction, the second horizontal direction, and the vertical direction are defined in a similar manner to FIG. 1. FIG. 2 shows a state where the battery 100 as the liquid injection target has been brought into the liquid injection chamber 2. Liquid has not been injected by the liquid injection device 1 into the battery 100 shown in FIG. 2. When a plurality of batteries 100 are brought into the liquid injection chamber 2, the battery 100 shown in FIGS. 2 to 4 represents a battery 100 selected as the liquid injection target. When liquid injection is executed on all of the batteries 100, the liquid injection device 1 repeatedly executes the liquid injection operation to be described below.

As shown in FIG. 2, the liquid injector 3 is moved to a position that enables injection of an electrolytic solution into the battery 100 by driving a driver (not shown). The position of the liquid injector 3 relative to the battery 100 is adjusted by the controller 9 based on the information on the position of the liquid injector 3 detected by the second detection mechanism 82. In the present embodiment, the controller 9 controls the position of the liquid injector 3 so that the liquid injector 3 can inject the electrolytic solution through the liquid injection port 102 of the battery 100. When a hopper is used as the liquid injector 3, the controller 9 controls the position of the liquid injector 3 so that an opening of a drain provided in the hopper can be connected to an opening of the liquid injection port 102. After the liquid injector 3 is connected to the liquid injection port 102, the controller 9 controls supply of the electrolytic solution to be injected into the battery 100 to the liquid injector 3. The liquid volume of the electrolytic solution to be supplied to the liquid injector 3 is a volume set in advance in accordance with, for example, the type of the battery 100. The electrolytic solution is supplied to the liquid injector 3 through an electrolytic solution supply path (not shown). The electrolytic solution supply path is not particularly limited as long as it can supply an electrolytic solution to the liquid injector 3.

As shown in FIG. 3, after the electrolytic solution is supplied to the liquid injector 3, the controller 9 controls the depressurizer 6 to decrease the pressure inside the liquid injection chamber 2. Accordingly, the pressure inside the liquid injection chamber 2 decreases, and the pressure in the inner hollow of the battery 100 decreases. By a pressure difference being caused between the liquid injector 3 and the inner hollow of the battery 100, the electrolytic solution is injected from the liquid injector 3 into the inner hollow of the battery 100. The electrolytic solution moves from the liquid injection port 102 of the battery 100 to the inner hollow of the battery 100 in the direction of the broken-line arrow shown in FIG. 3. As the electrolytic solution moves to the inner hollow of the battery 100 in this manner, the liquid volume of the electrolytic solution retained in the liquid injector 3 decreases. Accordingly, the liquid level of the electrolytic solution in the liquid injector 3 moves downward in the vertical direction. The controller 9 determines the status of the liquid injection by the liquid injector 3 based on information on the electrolytic solution detected by the first detection mechanism 81. In an example, the controller 9 determines that liquid injection by the liquid injector 3 has been completed based on the liquid level of the electrolytic solution matching the lowest level of the bottom of the inside of the liquid injector 3. In another example, the controller 9 determines that liquid injection by the liquid injector 3 has been completed based on the liquid volume of the electrolytic solution being zero.

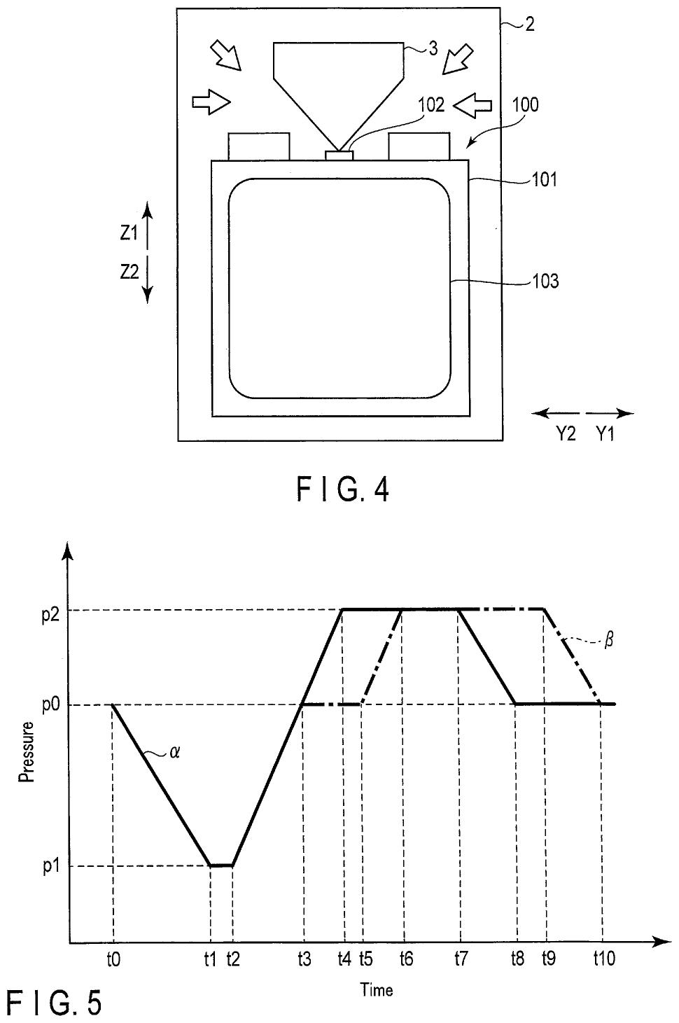

As shown in FIG. 4, after completion of the liquid injection by the liquid injector 3, the controller 9 controls the pressurizer 5 to increase the pressure inside the liquid injection chamber 2. Accordingly, the pressure inside the liquid injection chamber 2 increases, and the pressure in the inner hollow of the battery 100 increases. The electrode group 103 disposed in the inner hollow of the battery 100 is then impregnated with the electrolyte solution injected into the inner hollow of the battery 100. The controller 9 controls the pressurizer 5 to increase the pressure inside the liquid injection chamber 2, based on a predetermined period of time. After a passage of a predetermined period of time, the controller 9 controls the pressure release 7 to decrease the pressure inside the liquid injection chamber 2. In an example, the controller 9 controls the pressure release 7 to decrease the pressure inside the liquid injection chamber 2 to the atmospheric pressure. In this manner, the electrode group 103 disposed in the inner hollow of the battery 100 is impregnated with the electrolyte solution.

Next, examples of a temporal change of the pressure inside the liquid injection chamber 2 during injection of the electrolytic solution into the battery 100 will be described. FIG. 5 is a schematic view showing examples of a temporal change (pressure profile) of the pressure inside the liquid injection chamber 2 during liquid injection. In FIG. 5, the abscissa axis represents the elapsed time from the start of pressure adjustment of the liquid injection chamber 2 by the pressure regulator 4, and the ordinate axis represents the pressure inside the liquid injection chamber 2. Line α (solid line) and line β (dashed line) each represent a temporal change of the pressure inside the liquid injection chamber 2, i.e., a pressure profile. Hereinafter, the pressure profile indicated by line α will be referred to as pressure profile A, and the pressure profile indicated by line β will be referred to as pressure profile B.

In FIG. 5, pressures p0, p1, p2 are defined. Pressure p0 is a pressure inside the liquid injection chamber 2 in a state (initial state) before the pressure inside the liquid injection chamber 2 starts to be adjusted by the pressure regulator 4. The pressure p0, which is the pressure of the initial state, is for example a pressure at the time when the battery 100 is brought in through a transfer path (not shown) (or by being mounted on a transfer stand, such as a transfer tray), and thereby is accommodated in the liquid injection chamber 2, i.e., the atmospheric pressure. The pressure p1 is the lower limit pressure of the pressure inside the liquid injection chamber 2 at the time of being adjusted by the pressure regulator 4. The lower limit pressure is preferably, for example, from −98 kPa to −10 kPa with reference to the pressure p0. When the pressure p0 is the atmospheric pressure, the lower limit pressure is preferably from −98 kPa to −10 kPa in gauge pressure. Pressure p2 is the upper limit pressure of the pressure inside the liquid injection chamber 2 at the time of being adjusted by the pressure regulator 4. The upper limit pressure is preferably, for example, from 0.2 MPa to 4.0 MPa. The upper limit pressure is lower than or equal to the design pressure of the liquid injection chamber 2. The state where the pressure inside the liquid injection chamber 2 is higher than pressure p0 is defined as the pressurized state, and the state where the pressure inside the liquid injection chamber 2 is lower than pressure p0 is defined as the depressurized state.

In the case of pressure profile A shown in FIG. 5, the pressure regulator 4 starts to adjust the pressure inside the liquid injection chamber 2 at time to. From time t0 to time t1, the pressure inside the liquid injection chamber 2 is decreased by the pressure regulator 4 (depressurizer 6) to pressure p1. For example, the pressure inside the liquid injection chamber 2 monotonically decreases from time t0 to time t1. As the pressure inside the liquid injection chamber 2 decreases, the pressure in the inner hollow of the battery 100 decreases; accordingly, the electrolytic solution retained in the liquid injector 3 is injected into the battery 100 from the liquid injector 3, as described above.

When the pressure inside the liquid injection chamber 2 reaches p1 at time t1, the pressure regulator 4 maintains the pressure inside the liquid injection chamber 2 at p1 for a predetermined period of time. While the pressure inside the liquid injection chamber 2 is p1, the liquid injector 3 completes the injection of the electrolytic solution retained in the liquid injector 3 into the battery 100. Namely, the pressure regulator 4 maintains the pressure inside the liquid injection chamber 2 at p1 until the liquid injection into the battery 100 is completed. During liquid injection into the battery 100, information on the electrolytic solution detected by the first detection mechanism 81, i.e., information on the liquid level of the electrolytic solution and/or information on the liquid volume of the electrolytic solution, decreases with time to the minimum values. After liquid injection into the battery 100 has been completed, information on the electrolytic solution detected by the first detection mechanism 81, i.e., information on the liquid level of the electrolytic solution and/or information on the liquid volume of the electrolytic solution, does not change or hardly changes with time from the respective values (minimum values and/or maximum values).

When the injection of the electrolytic solution retained in the liquid injector 3 into the battery 100 is completed at time t2, the pressure inside the liquid injection chamber 2 is released by the pressure regulator 4 (pressure release 7) to pressure p0 from time t2 to time t3. For example, the pressure inside the liquid injection chamber 2 monotonically increases from time t2 to time t3. As the pressure inside the liquid injection chamber 2 increases, the pressure in the inner hollow of the battery 100 increases; accordingly, the inner hollow of the battery 100 expands, and the electrode group 103 provided in the inner hollow of the battery 100 is spread out. Namely, the positive electrode, negative electrode, and separator constituting the electrode group 103 are distanced from one another. Accordingly, the electrolytic solution in the inner hollow of the battery 100 penetrates into the electrode group 103, and the electrode group 103 is impregnated with the electrolytic solution. As described above, in the case of pressure profile A, the liquid injection chamber 2 is maintained in the depressurized state from time t0 to time t3.

In the case of pressure profile A, after the pressure inside the liquid injection chamber 2 reaches pressure p0 at time t3, the pressure inside the liquid injection chamber 2 is increased by the pressure regulator 4 (pressurizer 5) to pressure p2 from time t3 to time t4. From time t3 to time t4, for example, the pressure inside the liquid injection chamber 2 monotonically increases. From time t3 to time t4, the electrolytic solution in the inner hollow of the battery 100 penetrates into the electrode group 103 and impregnation of the electrode group 103 with the electrolytic solution progresses as in the period from time t2 to time t3. From time t3 to time t4, the pressure inside the liquid injection chamber 2, i.e., the pressure in the inner hollow of the battery 100, is higher than from time t2 to time t3. Thus, from time t3 to time t4, impregnation of the electrode group 103 with the electrolytic solution progresses better than from time t2 to time t3.

When the pressure inside the liquid injection chamber 2 reaches p2 at time t4, the pressure regulator 4 maintains the pressure inside the liquid injection chamber 2 at p2 from time t4 to time t7. Namely, the pressure inside the liquid injection chamber 2 is constant or approximately constant from time t4 to time t7. At time t7, the pressure regulator 4 starts to decrease the pressure inside the liquid injection chamber 2. From time t7 to time t8, the pressure inside the liquid injection chamber 2 is decreased by the pressure regulator 4 (pressure release 7) to pressure p0. For example, the pressure inside the liquid injection chamber 2 monotonically decreases from time t7 to time t8. At time t8, the pressure inside the liquid injection chamber 2 reaches p0. As described above, in the case of pressure profile A, the liquid injection chamber 2 is maintained in the pressurized state from time t3 to time t8.

In the above-described manner, in the case of pressure profile A, the liquid injection chamber 2 is brought to the depressurized state and then is brought to the pressurized state beyond the initial state of pressure p0, and is brought back to the initial state by means of the liquid injector 3 and the pressure regulator 4 (the pressurizer 5, the depressurizer 6, and the pressure release 7). Accordingly, the electrolytic solution is injected into the battery 100 disposed in the liquid injection chamber 2, and the electrode group 103 is appropriately impregnated with the electrolytic solution.

Pressure profile B shown in FIG. 5 is a pressure profile similar to the above-described pressure profile A from time t0 to time t3. When the pressure inside the liquid injection chamber 2 reaches the pressure p0 of the initial state at time t3, the pressure regulator 4 maintains the pressure inside the liquid injection chamber 2 at p0 from time t3 to time t5. Namely, the pressure inside the liquid injection chamber 2 is constant or approximately constant from time t3 to time t5.

The pressure inside the liquid injection chamber 2 is increased by the pressure regulator 4 (pressurizer 5) to pressure p2 from time t5 to time t6. For example, the pressure inside the liquid injection chamber 2 monotonically increases from time t5 to time t6. From time t5 to time t6, the electrolytic solution in the inner hollow of the battery 100 penetrates into the electrode group 103 and impregnation of the electrode group 103 with the electrolytic solution progresses as in the period from time t2 to time t3. From time t5 to time t6, the pressure inside the liquid injection chamber 2, i.e., the pressure in the inner hollow of the battery 100, is higher than from time t2 to time t3. Thus, from time t5 to time t6, impregnation of the electrode group 103 with the electrolytic solution progresses better than from time t2 to time t3.

When the pressure inside the liquid injection chamber 2 reaches p2 at time t6, the pressure regulator 4 maintains the pressure inside the liquid injection chamber 2 at p2 from time t6 to time t9. Namely, the pressure inside the liquid injection chamber 2 is constant or approximately constant from time t6 to time t9. At time t9, the pressure regulator 4 starts to decrease the pressure inside the liquid injection chamber 2. From time t9 to time t10, the pressure inside the liquid injection chamber 2 is decreased by the pressure regulator 4 (pressure release 7) to pressure p0. For example, the pressure inside the liquid injection chamber 2 monotonically decreases from time t9 to time t10. At time t10, the pressure inside the liquid injection chamber 2 reaches p0. As described above, in the case of pressure profile B, the liquid injection chamber 2 is maintained in the pressurized state from time t5 to time t10.

In the above-described manner, in the case of pressure profile B, the liquid injection chamber 2 is brought to the depressurized state and then maintained in the atmospheric pressure state for a predetermined period of time by means of the liquid injector 3 and the pressure regulator 4 (the pressurizer 5, the depressurizer 6, and the pressure release 7). Thereafter, the liquid injection chamber 2 is brought to the pressurized state beyond the atmospheric pressure state, and then brought back to the atmospheric pressure state. Accordingly, the electrolytic solution is injected into the battery 100 disposed in the liquid injection chamber 2, and the electrode group 103 is impregnated with the electrolytic solution.

As described above, according to a pressure profile of the liquid injection device 1, the pressure inside the liquid injection chamber 2 is decreased from the pressure p0 of the initial state, maintained at the lower limit pressure p1 for a certain amount of time, and then brought back to the pressure p0 of the initial state by pressure release.

Thereafter, the pressure inside the liquid injection chamber 2 is increased from the pressure p0 of the initial state, maintained at the upper limit pressure p2 for a certain amount of time, and then brought back to the pressure p0 of the initial state by pressure release. In other words, the pressure profile includes a depressurized state transition from the pressure of the initial state to the depressurized state and back to the pressure of the initial state, and a pressurized state transition from the pressure of the initial state to the pressurized state and back to the pressure of the initial state. The pressure profile may include one or more depressurized state transitions and one or more pressurized state transitions. However, the pressure profile includes at least one depressurized state transition conducted by the liquid injection device 1 prior to the pressurized state transition. In an example, after five depressurized state transitions are conducted by the liquid injection device 1, one pressurized state transition is conducted by the liquid injection device 1.

In an example, the controller 9 may control the pressure regulator 4 (the pressurizer 5, the depressurizer 6, and the pressure release 7) based on the elapsed time in the depressurized state and the elapsed time in the pressurized state. In this case, the period of time during which the liquid injection chamber 2 is in the depressurized state and/or the period of time during which the liquid injection chamber 2 is in the pressurized state are/is a predetermined period of time. The controller 9 maintains a pressure at which the liquid injection chamber 2 is in the depressurized state for a predetermined period of time. The controller 9 also maintains a pressure at which the liquid injection chamber 2 is in the pressurized state for a predetermined period of time. After maintaining the liquid injection chamber 2 in either the depressurized state or pressurized state for a predetermined period of time, the controller 9 changes the pressure of the liquid injection chamber 2 as appropriate.

In an example, the controller 9 may control the pressure regulator 4 (the pressurizer 5, the depressurizer 6, and the pressure release 7) based on information on the electrolytic solution detected by the detection mechanism 8. In this case, the controller 9 changes the pressure inside the liquid injection chamber 2 as appropriate based on a predetermined amount of the electrolytic solution retained in the liquid injector 3 having been injected into the battery 100.

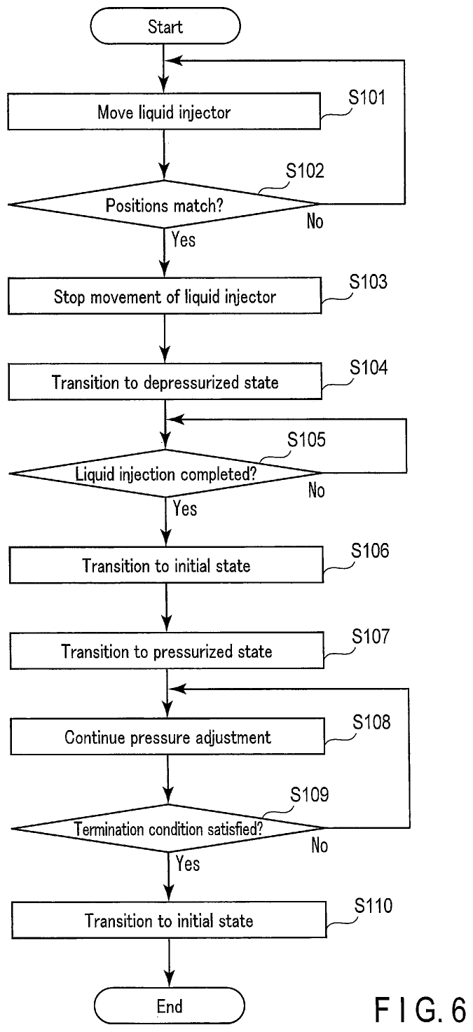

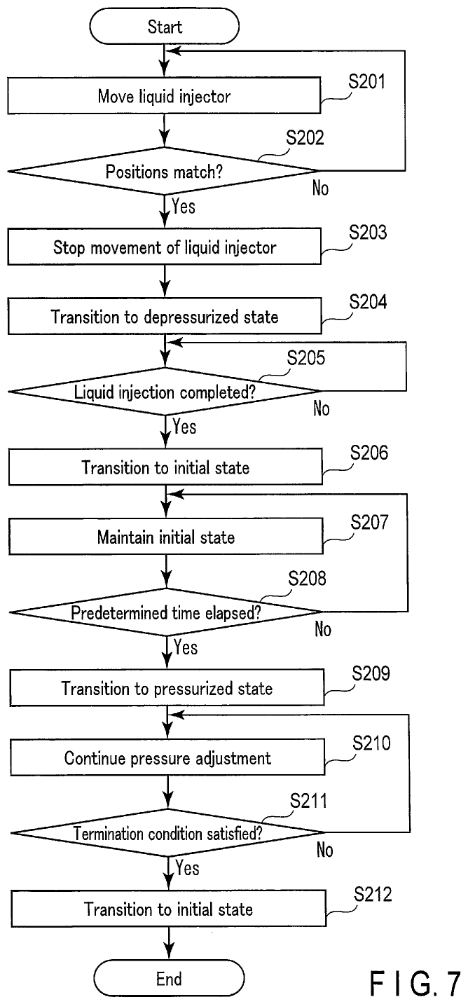

FIGS. 6 and 7 show processing executed by the controller 9 in a state where the battery 100 as a liquid injection target has been transferred to the liquid injection chamber 2. FIG. 6 shows an example of processing executed by the controller 9 in the case of pressure profile A shown in FIG. 5, and FIG. 7 is an example of processing executed by the controller 9 in the case of pressure profile B shown in FIG. 5. The processing shown in each of FIGS. 6 and 7 is executed by the controller 9 whenever a liquid injection operation is executed in the liquid injection device 1. Thus, the processing shown in each of FIGS. 6 and 7 is processing executed in one liquid injection of the liquid injection device 1.

In the processing shown in FIG. 6, i.e., the processing corresponding to pressure profile A, in the liquid injection device 1, the controller 9 controls a driver for driving the liquid injector 3 to move the liquid injector 3 (8101). The controller 9 adjusts the position of the liquid injector 3 based on information on the position of the liquid injector detected by the second detection mechanism. When the position of the drain of the liquid injector 3 does not match the position of the liquid injection port of the battery 100 (No in S102), the controller 9 sequentially performs the steps from S101 onward. When the position of the drain of the liquid injector 3 matches the position of the liquid injection port of the battery 100 (Yes in S102), the controller 9 controls the driver to stop the movement of the liquid injector 3 (S103).

The controller 9 controls the pressure regulator 4 (depressurizer 6) to cause a transition of the liquid injection chamber 2 to the depressurized state (S104). As described above, the transition of the liquid injection chamber 2 to the depressurized state initiates injection of the electrolytic solution from the liquid injector 3 into the battery 100. The controller 9 determines whether or not the liquid injection has been completed based on information on the liquid level of the electrolytic solution and/or the liquid volume of the electrolytic solution detected by the first detection mechanism (S105). When it is determined that the liquid injection has not been completed (No in S105), the processing returns to S104, and the steps from S104 onward are sequentially performed. When it is determined that the liquid injection has been completed (Yes in S105), the controller 9 controls the pressure regulator 4 (pressure release 7) to cause a transition of the liquid injection chamber 2 to the initial state (S106). As described above, in the case of pressure profile A, the liquid injection chamber 2 transitions to the pressurized state subsequently to the transition to the initial state. Thus, the controller 9 controls the pressure regulator 4 (pressurizer 5) to cause the transition of the liquid injection chamber 2 to the pressurized state (S107).

After the processing in S107, the controller 9 controls the pressure regulator 4 to continue the pressure adjustment of the liquid injection chamber 2 (S108). In S108, the controller 9 causes, for example, the liquid injection chamber 2 to transition to the pressurized state, depressurized state, or initial state as appropriate. The controller 9 determines whether or not the liquid injection device 1 satisfies a termination condition (S109). When it is determined that the liquid injection device 1 does not satisfy the termination condition (No in S109), the controller 9 sequentially performs the steps from S108 onward. When it is determined that the liquid injection device 1 satisfies the termination condition (Yes in S109), the controller 9 controls the pressure regulator 4 (pressure release 7) to cause a transition of the liquid injection chamber 2 to the initial state (S110). In an example, the termination condition is that the pressurized state has continued for a predetermined period of time. The liquid injection into the battery 100 by the liquid injection device 1 is accordingly completed.

In the processing shown in FIG. 7, i.e., the processing corresponding to pressure profile B, the processing from S201 to S206 is similar to the processing from S101 to S106 shown in FIG. 6, and the processing from S209 to S212 is similar to processing from S107 to S110 shown in FIG. 6. In the processing shown in FIG. 7, the processing in S207 and S208 differs from the processing shown in FIG. 6.

In the processing shown in FIG. 7, the controller 9 maintains the liquid injection chamber 2 in the initial state after completion of the processing of S206 (S207). The controller 9 determines whether or not the liquid injection chamber 2 has been maintained in the initial state for a predetermined period of time (S208). When it is determined that the liquid injection chamber 2 has not been maintained in the initial state for the predetermined period of time (No in S208), the controller 9 sequentially performs the steps from S207 onward. When it is determined that the liquid injection chamber 2 has been maintained in the initial state for the predetermined period of time (Yes in S208), the controller 9 performs the steps from S209 onward in the above-described manner. The liquid injection into the battery 100 by the liquid injection device 1 is accordingly completed.

As described above, according to the present embodiment, the liquid injection device 1 includes the liquid injection chamber 2, the liquid injector 3, the pressure regulator 4, and the controller 9. The liquid injection chamber 2 accommodates, in the initial state, the battery 100, which includes the exterior container 101 provided with a liquid injection port. In the liquid injection chamber, the liquid injector 3 injects an electrolytic solution into the exterior container through the liquid injection port. The pressure regulator 4 adjusts the pressure inside the liquid injection chamber 2. The controller 9 controls the action of the pressure regulator 4 to bring the liquid injection chamber 2 to a depressurized state, in which the pressure is lower than in the initial state, and then bring the liquid injection chamber 2 to a pressurized state, in which the pressure is higher than in the initial state. Accordingly, the electrode group 103 disposed in the exterior container 101 is appropriately impregnated with the electrolytic solution in the above-described manner. Accordingly, for example, the electrode group 103 can be appropriately impregnated with the electrolytic solution in a short time. Consequently, depressurization processing at the time of sealing the liquid injection port 102 after impregnation of the electrode group 103 with the electrolytic solution can effectively prevent the electrolytic solution from overflowing from the battery 100.

A liquid injection device according to at least one of the embodiments includes a liquid injection chamber, a liquid injector, a pressure regulator for adjusting the pressure inside the liquid injection chamber, and a controller. In the liquid injection chamber, the liquid injector injects an electrolytic solution into an exterior container of the battery through a liquid injection port. The controller controls the action of the pressure regulator to bring the liquid injection chamber to a depressurized state and then bring the liquid injection chamber to a pressurized state. This enables provision of a liquid injection device and liquid injection method capable of appropriately impregnating an electrode group with the electrolytic solution in a short time.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A liquid injection device comprising:
a liquid injection chamber configured to accommodate a battery in an initial state, the battery including an exterior container provided with a liquid injection port;
a liquid injector configured to inject an electrolytic solution into the exterior container through the liquid injection port in the liquid injection chamber;
a pressure regulator configured to adjust a pressure inside the liquid injection chamber; and
a controller configured to control an action of the pressure regulator to bring the liquid injection chamber to a depressurized state, in which the pressure inside the liquid injection chamber is lower than in the initial state, and then bring the liquid injection chamber to a pressurized state, in which the pressure inside the liquid injection chamber is higher than in the initial state.

2. The liquid injection device according to claim 1, wherein the controller controls the action of the pressure regulator to bring the liquid injection chamber to the depressurized state while injecting the electrolytic solution into the exterior container through the liquid injector.

3. The liquid injection device according to claim 2, wherein the controller controls the action of the pressure regulator to bring the liquid injection chamber to the initial state and maintain the liquid injection chamber in the initial state for a predetermined period of time, after injecting the electrolytic solution into the exterior container before bringing the liquid injection chamber to the pressurized state.

4. The liquid injection device according to claim 1, wherein the controller controls the action of the pressure regulator to cause the liquid injection chamber to change from the depressurized state after maintaining the pressure inside the liquid injection chamber in the depressurized state at a predetermined pressure for a predetermined period of time.

5. The liquid injection device according to claim 1, wherein the controller controls the action of the pressure regulator based on information on the electrolytic solution in the liquid injector.

6. The liquid injection device according to claim 1, wherein the pressure regulator includes a pressurizer to bring the liquid injection chamber to the pressurized state and a depressurizer to bring the liquid injection chamber to the depressurized state, the depressurizer being separate from the pressurizer.

7. A liquid injection method comprising:
accommodating a battery in an initial state, the battery including an exterior container provided with a liquid injection port;
injecting an electrolytic solution into the exterior container through the liquid injection port in the liquid injection chamber;
bringing the liquid injection chamber to a depressurized state in which a pressure inside the liquid injection chamber is lower than in the initial state; and
bringing the liquid injection chamber to a pressurized state in which the pressure inside the liquid injection chamber is higher than in the initial state, after bringing the liquid injection chamber to the depressurized state.
